(19) United States
(12) Patent Application Publication
(10) Pub. No.: US 2004/0035705 A1
(43) Pub. Date: Feb. 26, 2004

(54) Method for coating a membrane electrode unit with a catalyst and device for carrying out the method

(76) Inventors: Rolf Hempelmann, St Ingbert (DE); Marc Simon Loffler, Saarbrucken (DE); Heinz Schmitz, Julich (DE); Harald Natter, Saarbrucken (DE); Jiri Divisek, Julich (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/343,370

(22) PCT Filed: Jul. 21, 2001
(86) PCT No.: PCT/DE01/02830

(30) Foreign Application Priority Data
Aug. 4, 2000 (DE) 100 38 862.0

(51) Int. Cl. H01M 4/88

(52) U.S. Cl. 205/108; 502/101

(57) ABSTRACT

The invention relates to a method for electrochemically depositing a catalyst, especially a noble metal, from a precursor layer which is present on a membrane and in which the catalyst material is present in the form of salts that are soluble in the membrane material. According to the method, the membrane is surrounded by an atmosphere containing water vapour during the deposition process, this atmosphere ensuring the stability and ionic conductibility of the membrane. In contrast to methods used up until now, this prevents the soluble catalyst salt from being dissolved out the precursor layer. The method can be carried out in a simple device comprising a sealable vessel which can be advantageously tempered, a holder for receiving a membrane/precursor unit, a gas supply and electrical contacts.

### TECHNICAL FIELD

The invention relates to a method of coating a membrane-electrode unit of a fuel cell with a catalyst as well as to an apparatus suitable for that purpose.

### STATE OF THE ART

The membrane electrode units (MEA), which are assembled from layers arranged in a sandwich-like pattern of electrode/membrane/electrode, are the central elements of a fuel cell. For fuel cells which have an operating temperature of 0 to 150° C., ion-conducting solid electrolyte membranes on a polymer basis are used. The anodes for the hydrogen oxidation and the cathode for oxygen reduction are primarily of platinum. The anodes for the methanol oxidation of the direct methanol fuel cell (DMFC) are coated for example with platinum-ruthenium.

The principle of a fuel cell is known from the publication “K. Kordesch, G. Simander: Fuel Cells and their Applications”, VCH Weinheim, 1996”.

There, in addition, different methods for making membrane-electrode units (MEA) for fuel cells are described. The catalytically active layer is as a result disposed at the phase boundary between the gas diffusion layer (backing layer) and polymer electrolyte.

The application of the catalyst can be typically effected in two ways: On the one hand, the electrode can be applied on the diffusion coating of the gas diffusion electrode by depositing a thin platinum layer thereon (Electrochimica Acta 38 (1993) 1661).

On the other hand the catalyst layer can be applied to the membrane as has been first shown, for example, in U.S. Pat. No. 3,297,484. A comprehensive description of the different coating processes is found in the publication: Advances in Electrochemical Science and Technology, Volume 5, R. C. Alkire, editor, Wiley-VCH Publishing, Weinheim, 1997.

The catalytic layers produced by most of these processes have a relatively high catalyst coating with the noble metal so that especially in the case of the DMFC, the amount of catalyst used as a result is so high that the entire process is uneconomical.

From U.S. Pat. No. 5,084,144 as well as from the publication E. J. Taylor et al., Journal of the Electrochemical Society, Vol. 139 (1992) pages 45-46, electrochemical coating processes for producing gas diffusion electrodes are known which have the goal of achieving an especially low platinum coating through high platinum utilization. This is effected chemically in accordance with the electrochemical coating method since the metallic nuclei only can deposit where an electrochemically-active three-phase boundary can occur. According to the invention for producing thin catalytically-active layers, an electrolytic deposition of a catalyst metal from a galvanic bath is carried out. It is a drawback that in this method galvanic baths containing expensive noble metal are required that must be prepared by expensive and cost-intensive steps. In addition the utilization of the noble metal dissolved in the galvanic bath is very limited so that the advantages obtained with optimum deposition are lost, for example by a rinsing step.

To avoid these drawbacks, DE 197 20 688 C1 proposes a process in which the noble metal source itself in the Nafion solution is applied as a precursor layer between the diffusion layer of the electrodes and the electrolyte layer and then the noble metal is electrically deposited in a targeted manner between the electron conductor and the electrolyte in the active three-phase zone. Advantageously with this process no expensive galvanic bath is required any longer. The corresponding reaction equations are:

Cathode (Precursor):

H₂PtCl₆+4H⁺+4e⁻=Pt⁰+6 HCl

Counter Electrode:

2H₂O=4H⁺+4e⁻+O₂

The execution of the process is described in DE 197 20 688 C1. Since the process has been conceived above all for polymer electrolyte membranes as MEA elements of a fuel cell, it must be ensured that the membrane maintains its conductivity during the coating process by continuously moisturizing it with water. The membrane is brought into contact with liquid water, the water permeates through the membrane and the membrane is maintained in this manner suitably in a moist state. It has, however, been found that the water partly flushes the water soluble noble metal salts out of the active intermediate layer so that, undesired losses of material can thereby arise. It is therefore necessary to overcome this disadvantage.

### OBJECTS AND SOLUTION

The object of the invention is to provide a method whereby a catalyst coating of a membrane or a fuel cell can be made so that the amount of the catalyst material used is minimized and an approximately complete utilization of the catalyst material in the coating is ensured.

Further it is an object of the invention to obtain a suitable apparatus for carrying out the above-mentioned method according to the invention.

The objects are achieved through a process according to the main claim as well as with an apparatus according to the dependent claims. Further advantageous embodiments are given in the claims which are dependent therefrom.

### DESCRIPTION OF THE INVENTION

The method of electrochemical deposition of a catalyst from a precursor layer for a fuel cell according to claim 1 encompasses the following steps:

1. A precursor layer, which contains the catalyst, is applied to a membrane.

2. During the deposition, the membrane is maintained in an atmosphere containing water vapor.

The precursor layer in the sense of the invention is a layer which contains the membrane material, for example Nafion, and encompasses the catalyst material, for example in the form of salts soluble in the membrane material. Catalysts which are suitable for use in a fuel cell are for example: noble metals (platinum Pt, Ruthenium Ru) in pure form and/or also as mixtures. They catalyze the electrochemical conversion of the fuel medium or the oxidation media in the fuel cell.

As for the membranes, they are typically ion-conducting solid electrolyte membranes, for example on a polymer basis. A commercial supplier of these membranes is Nafion®. Further suitable membranes with similar characteristics are, for example, Dow-membranes® or Neosepta® membranes.

According to the invention it has been found that for the deposition from a precursor layer, it suffices to maintain the membrane in an atmosphere containing water vapor. This atmosphere has the effect of assuring an ionic conductivity of the membrane during the deposition and the stability of the membrane by a water vapor containing, in the sense of the invention, an atmosphere should be understood which has a partial pressure of water of 0.01-2.0 bar. This means that also water contents which are clearly below a saturation of the atmosphere will yield the advantageous effects.

The deposit of the metallic catalyst is effected advantageously only in the regions in which there is both ionic contact with the membrane as well as an electronic contact.

At the same time with the method of the invention, a subsequent flushing, which has been customary in the state of the art, can be eliminated. As a result there is also usually no loss of catalyst material as regularly arose otherwise during the flushing step.

The method of the invention can be carried out with simple apparatus, since only a temperature-controllable vessel is required in which an atmosphere containing water vapor can be provided and in which the electrochemical deposition of the catalyst can be effected.

Advantageously during the deposition process a water-vapor-containing air or nitrogen atmosphere is introduced. Further possibilities for a suitable atmosphere are protective gasses containing water vapor. The atmosphere should not sustain any chemical reaction with the membrane or precursor layer. For example in the use of water soluble catalyst material in the precursor layer, the atmosphere should not have reductive characteristics since then the catalyst will chemically precipitate in the precursor layer in an undefined manner. Water soluble catalyst material has the advantage that it is simple to handle and also soluble in the membrane material.

To control the particle size of the deposited catalyst particles, either a constant current process or the pulsed current process can be used for deposition.

The method is advantageously carried out at moderate temperatures around room temperature.

An upper temperature limit is given for the artisan by the material used, especially the catalyst salts. Pt(NO₃) decomposes as a soluble catalyst salt at about 250°, while H₂PtCl₆ decomposes already at 50° C. so that the temperature should lie below these temperatures for deposition with these catalyst salts.

The apparatus according to the invention for carrying out the method according to the auxiliary claim encompasses:

a closable vessel,

means for adjusting a water vapor containing atmosphere within the vessel, as well as

a holder for a membrane/precursor unit,

electrical contacts for generating an electric field in a membrane/precursor unit introduced into the holder.

A simple vessel suitable for the method is for example a glass receptacle with a cover. Furthermore, the apparatus comprises a means for providing a water vapor containing atmosphere within the vessel. This means can be constituted of a gas inlet to the vessel in which the gas prior to entry into the vessel is saturated with water, for example, in the form of a wash bottle upstream of the vessel. However, it is not essential to achieve a saturation of the gas with water vapor. For the electrochemical deposition, within the vessel a holder to receive the membrane/precursor unit is provided. The holder thus encompasses advantageously an electrically-conductive support for the precursor layer and a means for homogeneously distributing an electric charge over the membrane, for example in the form of a graphite mesh.

By appropriate electrical contacts with the holder, an electrical field can be produced in the membrane/precursor unit.

Advantageously, the water vapor enrichment of the atmosphere is carried out directly in the vessel. In that case, gas, for example nitrogen, is supplied via a feed line to the bottom of the vessel whereby above the outlet a water column stands. The outflowing gas bubbles through suitable outlet openings of the feed line (frit) through the water and is thus enriched with water vapor. By temperature control [heating], the enrichment can be increased. For that purpose the vessel can be equipped advantageously so as to be temperature controlled [heated]. With this embodiment it can be noted that the holder for the membrane/precursor unit does not lie in direct contact with the water and the electrical contacts are correspondingly insulated.

### DESCRIPTION OF THE DRAWING

FIG. 1 shows schematically the catalytically active zone between the backing layer of the electrode which is only ion-contacting (membrane). Only in this zone does the metallic catalyst deposit. On the one hand the electrons pass out of the electrode only up to it since the electrolyte itself is not electron-conductive. On the other hand the initial ionic catalyst salt is found only in this zone together with the ion-conducting electrolyte material. Only at the passages which are formed in this zone through the electrolyte material (passages shown black), is there advantageously a contact between ionic catalyst particles and electrons from the electrode and thus a deposition of the metallic catalyst in the form of individual particles (points shown as grey). In addition the carbon particles are indicated in this Figure as arise for example with a carbon-containing precursor sample.

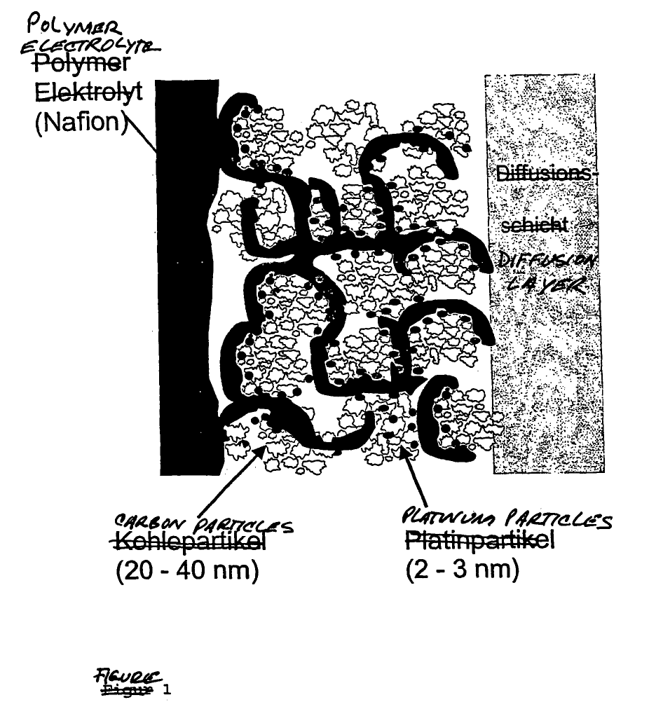

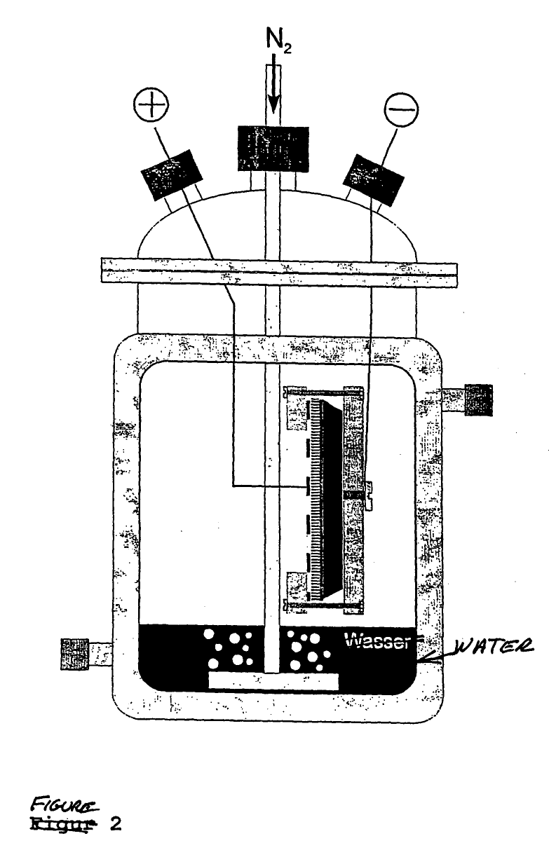

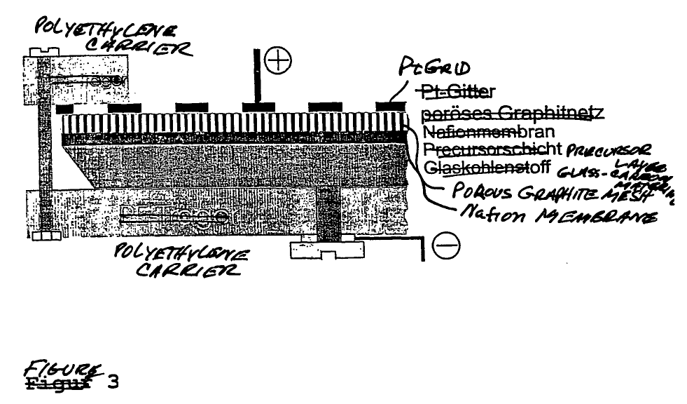

In FIG. 2a a possible embodiment of the apparatus of the invention for carrying out the method according to the invention has been shown. The apparatus is comprised of a closable and temperature-controlled [heatable] vessel. Advantageously such a glass vessel can be a wash bottle. The bottom of the vessel is covered with water. In the vessel a gas supply line feeds gas so that the gas emerges at the bottom of the vessel through a bubbler device (frit). It can thereby be assured that above the water the gas atmosphere will be saturated with water. The temperature control [heating] of the vessel and the water ensure an appropriate partial pressure adjustment of the water in the gas phase.

Furthermore, a holding device is provided for the membrane to be treated, supporting the latter with the precursor which has been supplied above the water level. Electrical contacts extend from the exterior into the vessel to the holding device.

In FIG. 2b an embodiment of the holding device of the invention is illustrated in a more detailed manner. This embodiment is provided for a one-sided catalyst coating.

The membrane/precursor unit is clamped between a glass-carbon layer and a graphite mesh with a platinum grid laid thereof between two polyethylene supports. The precursor layer is thereby bounded at the glass-carbon layer and the membrane with an oxidation catalyst coating graphite mesh. In the case of one-sided coating, the one polyethylene carrier can be configured as a plate. The glass-carbon layer and the platinum grid are electrically connected. The combination of the platinum grid and the graphite mesh effects a simultaneous electrical contact with the membrane over its entire area. This combination can also be formed otherwise.

In FIG. 3, the differences in the compositions of the catalytically-active layer before and after the electrochemical deposition is shown in an X-ray diffraction diagram. Before the deposition no metallic platinum can be recognized in the diagram, where after the deposition individual peaks from the deposition of metallic platinum in different planes, e.g. (Pt (111), Pt (200), Pt (220), etc. can be seen.

### EXAMPLE

The noble metal salts (for example platinum salts) or noble metal salt mixtures (for example Pt/Ru salts) are applied by a suitable process to the membrane. A water-soluble salt should be used, for example Pt(NO₃)₂ or H₂PtCl₆ (hexachloroplatinic acid). The following are the process as:

1. Pt(NO₃)₂

The platinum nitrate solution is mixed with the Nafion solution and poured onto a PtFe foil and dried. The layer is then pressed at 130° C. on the Nafion 117 membrane. The following precursor sample was thereby obtained:

Sample 1: 0.5 mg Pt/cm² (10% Nafion)

2. Hexachloroplatinic Acid

Vulcan XC-72 was compounded with the Nafion solution, mixed and sprayed on a Teflon foil (Nafion contact: 21.4%)

The layer is dried and is pressed at 130° C. onto a Nafion membrane. Thereafter the Teflon foil is drawn off. On the remaining carbon layer a mixture of hexachloroplatinic acid with Nafion is brushed then, and then is dried at 35 to 40° C.

The following precursor sample is obtained.

| Vulcan XC-72: | 1.73 mg/cm² |
|---|---|
| Platinum: | 1.0 mg/cm² |
| Platinum on carbon: | 36.63% |
| Nafion content: | 36.43% |

The membrane coated with platinum is so applied to a carbon carried that the precursor layer is found on the side turned toward the carbon. The membrane is pressed with a graphite mesh as a conductor onto a carbon carrier. The device according to the invention is so fastened in a water-filled vessel that it has no contact with liquid water. The conductors required for the deposition are provided in the upper part of the vessel. The entire vessel is flushed with nitrogen as a carrier gas which for saturation with water is conducted through the water.

Subsequently a galvanostatic noble metal precipitation is carried out for example with pulsed electrical current. As a result, a membrane coated with electrochemically-deposited catalyst is obtained which can be introduced as MEA in a polymer electrolyte fuel cell. The difference in the composition of the catalytically-active layer before the deposition (no metallic platinum) and after the deposition (metallic platinum is detected) is shown in the X-ray diffractogram of FIG. 3.

### Commercial Utility

The method according to the invention for producing a membrane electrode unit coated with a catalyst for a fuel cell has, by comparison with the state of the art, the advantage that no expensive galvanic bath is necessary. By comparison with conventional depositions from a precursor layer, the method of the invention has the advantage that during the deposition no expensive catalyst material is rinsed out. As to this point, the otherwise conventional flushing step is eliminated along with its usual loss of flushed-out catalyst material.

The method which can be carried out with a simple apparatus results in a significant cost saving in the production of membrane electrode units with effective catalyst coatings in reducing the requisite catalyst quantity.

1. A method of electrochemical depositing a catalyst from a precursor layer for a fuel cell with the steps
a precursor layer is brought into contact with a membrane,
during deposition, the membrane is disposed in a water-vapor-containing atmosphere.

2. The method according to claim 1, characterized by
a water vapor containing atmosphere with a water partial pressure in the range of 0.01-2.0 bar.

3. The method according to claim 1, characterized by a water-vapor-containing air atmosphere.

4. A method according to claim 1 characterized by a water-soluble catalyst salt in the precursor layer.

5. A method according to claim 1 characterized by a pulsed deposition.

6. A method of carrying out the method according to claim 1 comprising
a temperature controllable closable vessel,
means for providing a water vapor containing atmosphere within the vessel,
a holder for a membrane/precursor unit,
electrical contacts for producing an electric field in a membrane/precursor unit contained in the holder.

7. The apparatus according to claim 6 characterized by a gas supply with a wash bottle upstream thereof as means for providing a water vapor containing atmosphere within the vessel.

8. The apparatus according to claim 6 characterized by
a vessel for receiving water,
a gas supply which feeds the gas to the bottom of the vessel as means for providing the water vapor containing atmosphere
a holder which is so placed that the member/precursor unit has no contact with the water in the vessel.
